(19) United States
(12) Patent Application Publication
(10) Pub. No.: US 2014/0170571 A1
(43) Pub. Date: Jun. 19, 2014

(54) COMBUSTION CONTROL ELECTRODE ASSEMBLIES, SYSTEMS, AND METHODS OF MANUFACTURING AND USE

(71) Applicant: ClearSign Combustion Corporation, Seattle, WA (US)

(72) Inventors: Vincenzo Casasanta, III, Woodinville, WA (US); Joseph Colannino, Mercer Island, WA (US); Robert E. Breidenthal, Seattle, WA (US); David B. Goodson, Seattle, WA (US); Igor Alexeevitch Krichtafovitch, Kirkland, WA (US); Christopher A. Wiklof, Everett, WA (US)

(73) Assignee: ClearSign Combustion Corporation, Seattle, WA (US)

(21) Appl. No.: 14/104,612

(22) Filed: Dec. 12, 2013

Related U.S. Application Data
(60) Provisional application No. 61/737,033, filed on Dec. 13, 2012.

(51) Int. Cl. F23N 5/00; B23K 26/34; C25D 15/00; F27B 21/00

(52) U.S. Cl. CPC F23N 5/00; F27B 21/00; B23K 26/345; C25D 15/00
USPC 431/8; 431/253; 432/13; 219/121.66; 205/109; 427/58

(57) ABSTRACT

Combustion control electrode assemblies, combustion control systems using such assemblies, and methods of manufacturing and using such assemblies are disclosed. The electrode assemblies may include one or more electrodes including a sintered refractory metal material for heat and/or wear resistance. In an embodiment, an electrode assembly for a combustion control system may include at least one substrate and at least one electrode formed on the at least one substrate. The at least one electrode may include a sintered refractory metal material. The at least one electrode may be configured to be mounted proximate to or contacting a flame. The electrode assembly may further include at least one voltage source operatively coupled to the at least one electrode. The at least one electrode and the at least one voltage source may be collectively configured to apply an electric field to one or more regions at least proximate to the flame.

### CROSS-REFERENCE TO RELATED APPLICATIONS

This application claims priority to U.S. Provisional Application No. 61/737,033 filed on 13 Dec. 2012, the disclosure of which is incorporated herein, in its entirety, by this reference.

### BACKGROUND

Electric-field-based combustion control systems use electric fields to manipulate the movement of electrically charged molecules (e.g., ions) that are a natural production of the combustion process. The controlled electric field creates electrostatic forces (e.g., Coulombic body forces) within a gas cloud created by the combustion process that can be manipulated to control flame shape, heat transfer, and other flame characteristics. At the same time, the controlled electric field can help influence combustion chemistry to suppress formation of pollutants at the flame source.

Generally, these combustion control systems involve the use of one or two or more tubular, planar, or post-type electrodes fabricated from macroscopic metallic sheets, pipes, or rods. However, the ability of such electrodes to control electric fields can be limited and lacking in precision. Moreover, such electrodes can be susceptible to heat-induced failure and/or significant wear.

Therefore, developers and users of combustion control systems continue to seek improved designs for combustion control systems and methods of manufacturing of combustion control systems.

### SUMMARY

Embodiments of the invention relate to combustion control electrode assemblies, combustion control systems using such electrode assemblies, and methods of manufacturing and using such electrode assemblies. The electrode assemblies may include one or more electrodes formed from and/or including a sintered refractory metal material exhibiting enhanced heat and/or wear resistance.

In an embodiment, an electrode assembly for a combustion control system may include at least one substrate and at least one electrode formed on the at least one substrate. The at least one electrode may include a sintered refractory metal material. The at least one electrode may be configured to be mounted proximate to or contacting a flame. The electrode assembly may further include at least one voltage source operatively coupled to the at least one electrode. The at least one electrode and the at least one voltage source may be collectively configured to apply an electric field to one or more regions at least proximate to the flame.

In an embodiment, a combustion control system may include a combustion chamber including one or more walls at least partially defined by at least one electrode assembly. The at least one electrode assembly includes at least one substrate having at least one electrode formed thereon. The at least one electrode may include a sintered refractory metal material. The at least one electrode may be configured to be positioned proximate to or contacting a flame. The combustion control system may further include at least one voltage source operatively coupled to the at least one electrode. The at least one electrode and the at least one voltage source may be collectively configured to apply an electric field to one or more regions at least proximate to the flame.

In an embodiment, a method of manufacturing an electrode assembly for a combustion control system may include providing one or more precursor refractory metal materials on a substrate. The one or more precursor refractory metal materials may include a plurality of refractory metal material particles. The method may further include sintering at least a portion of the one or more precursor refractory metal materials on the substrate to form one or more electrodes. The one or more electrodes may be configured to be operatively coupled to one or more voltage sources so that an electric field can be applied to one or more regions at least proximate to a flame to control one or more combustion characteristics of the flame.

In an embodiment, a method of controlling combustion characteristics of a flame includes providing at least one electrode assembly including at least one substrate having a plurality of electrodes formed thereon that are positioned proximate to or contacting a flame. At least a number of the plurality of electrodes may include a sintered refractory metal material. The method may further include applying an electric field to one or more regions at least proximate to the flame via one or more voltage sources operatively coupled to the electrodes. The method may additionally include varying application of the electric field to control one or more combustion characteristics of the flame.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

FIG. 1 is a schematic isometric view of a combustion control system having an electrode assembly including at least one electrode that includes a sintered refractory metal material according to an embodiment.

FIG. 2 illustrates different isometric views of structures formed during a method of manufacturing an electrode assembly for a combustion control system according to an embodiment.

FIG. 3 is an isometric view of an electrode assembly according to another embodiment.

FIG. 4A is an isometric view of an electrode assembly forming a hollow three-dimensional structure according to another embodiment.

FIG. 4B is a partial cross-sectional view of the electrode assembly shown in FIG. 4A taken along line 4A-4A thereof illustrating how adjacent electrode sub-assemblies are electrically connected together.

FIG. 5 is a schematic isometric view of a combustion control system according to another embodiment.

FIG. 6 is a flowchart of a method for applying an electric field or voltage to a flame according to an embodiment.

FIG. 7 is a diagram of a plurality of ionizer stages for charging combustion component(s) according to an embodiment.

### DETAILED DESCRIPTION

Embodiments of the invention relate to combustion control electrode assemblies, combustion control systems using such electrode assemblies, and methods of manufacturing and using such electrode assemblies. The electrode assemblies may include one or more electrodes formed from and/or including a sintered refractory metal material exhibiting enhanced heat and/or wear resistance. In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

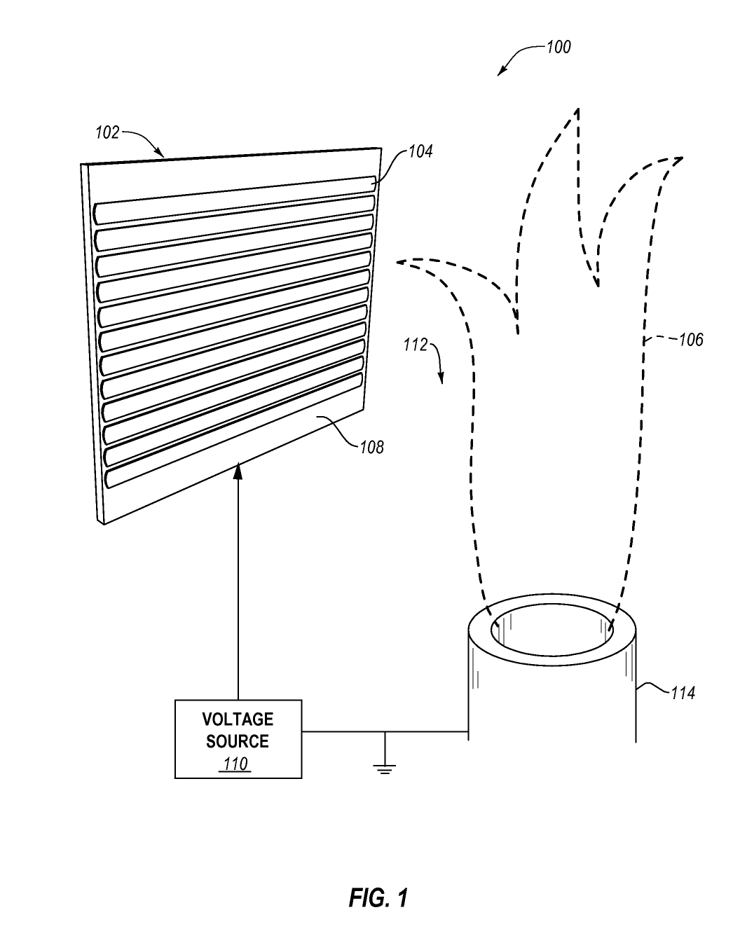

FIG. 1 is a schematic isometric view of a combustion control system 100 according to an embodiment. The combustion control system 100 may include an electrode assembly 102 having a plurality of electrodes 104 formed on and bonded to a substrate 108. The electrodes 104 may be configured to be mounted proximate to or in contact with a flame 106 for applying a controlled electric field to one or more regions 112 at least proximate (e.g., adjacent) to the flame 106 for controlling one or more characteristics of the flame 106. Each or some of the electrodes 104 may be electrically isolated from each other or electrically connected to each other.

In the illustrated embodiment, each of the electrodes 104 is formed in a generally strip or bar-like geometry. However, in other embodiments, the electrodes 104 may be formed in a variety of different geometries. Moreover, while twelve electrodes are shown, in other embodiments, the combustion control system 100 may include one, two, three, six, ten, or any other suitable number of electrodes. Additionally, while the combustion control assembly 100 is shown including only a single row of the electrodes 104, in other embodiments, the electrodes 104 may be arranged in one or more different patterns. For example, the electrodes 104 may be arranged in two rows, three rows, five rows, or any other suitable number of rows. In other embodiments, the electrodes 104 may be arranged in a generally circular pattern, a generally spiraling pattern, a generally rectilinear pattern, along one or more linear paths, along one or more arcuate paths, combinations thereof, or in any other suitable pattern or arrangement. Such configurations may help the electrodes 104 control the characteristics of the flame 106 at different locations and/or times during the combustion process.

At least one, two or more, or each of the electrodes 104 may be formed from and/or include a sintered refractory metal material. In an embodiment, the sintered refractory metal material includes sintered molybdenum, tungsten, niobium, tantalum, rhenium, alloys of one or more of the foregoing metals, combinations thereof, or any other suitable sintered material. For example, the alloys may be solid solution alloys, multi-phase alloys, intermetallic compounds (e.g., molybdenum disilicide, MoSi₂), or combinations thereof. Such sintered refractory metal materials may enable the electrodes 104 to resist heat and/or wear due to the material properties of the sintered refractory metal materials. For example, the sintered refractory metal material may exhibit a melting temperature or temperature range (e.g., a solidus temperature or a liquidus temperature) of about 1600° C., about 1800° C., about 2000° C., about 2200° C., 2400° C., 2600° C., 2800° C., 3000° C., 3000° C., or about 3200° C. In other embodiments, the sintered refractory metal material may exhibit a melting temperature or temperature range between about 1600° C. and about 3500° C.; about 1800° C. and about 3200° C.; about 2000° C. and about 3000° C.; or about 2300° C. and about 2800° C. In other embodiments, the sintered refractory metal material may exhibit higher or lower melting temperatures or temperature ranges. Thus, the electrodes 104 may be configured to withstand relatively high temperatures making them particular well suited for use in the combustion control system 100. In an embodiment, a sintered metal material or a sintered refractory metal material may be interchanged.

In an embodiment, at least one, two or more, or each of the electrodes 104 may include one or more electrically conductive coatings formed thereon. For example, the one or more conductive coatings exhibit an electrical resistivity less than an electrical resistivity of the sintered refractory metal material. Such electrically conductive coatings may include, for example, tin, manganese, vanadium, cobalt, zinc, cadmium, rhodium, chromium, titanium, nickel, silver, gold, alloys of one or more of the foregoing metals, combinations thereof, or any other suitable electrically conductive material. Such coatings may increase the electrical conductivity of the overall/composite electrodes 104 having the coating thereon. The one or more conductive coatings may be formed and/or deposited on the electrodes 104 via electroplating, electroless plating, combinations thereof, or via any other suitable application technique. For example, as the substrate 108 is relatively electrically insulative, the one or more conductive coatings may be preferentially deposited via electroplating on the electrodes 104 without electroplating coating material on intervening portions of the substrate 108 between the electrodes 104.

Referring still to FIG. 1, the substrate 108 may be configured to support the electrodes 104. The substrate 108 may include a generally flat planar first surface, an opposing generally flat planar second surface, and a plurality of generally planar sides forming a periphery of the substrate 108. The electrodes 104 may be selectively formed on one or more portions of the first surface of the substrate 108. The substrate 108 may exhibit any desired sized and geometric shape suitable for supporting the electrodes 104 for a particular combustion application. For example, the substrate 108 may exhibit a rectangular-like configuration. In other embodiments, the substrate 108 may exhibit a generally elliptical configuration, a generally cross-like configuration, a generally triangular configuration, a generally annular configuration, a generally T-like configuration, a generally diamond-like configuration, combinations thereof, or any other suitable configuration. While the first and second surfaces of the substrate 108 are shown being generally planar, in other embodiments, one or more portions of the surface of the substrate 108 may be generally curved, contoured, planar, combinations thereof, or other suitable geometry. The substrate 108 may be generally rigid, semi-rigid, semi-flexible, or flexible.

The substrate 108 may further exhibit any suitable thickness. For example, in an embodiment, the substrate 108 may exhibit a thickness of about 0.001 inches to about 0.8 inches; about 0.005 inches to about 0.25 inches; about 0.01 inches to about 0.02 inches; or about 0.1 inches to about 0.3 inches. In other embodiments, the substrate 108 may include one or more portions exhibiting a larger or smaller thickness. Thus, the substrate 108 may be configured to provide structural support to the electrodes 104, the combustion control system 100, one or more components of a combustion system, or combinations thereof. For example, in an embodiment, the substrate 108 may form at least a portion of a burner body, a support surface, a furnace wall, a combustion chamber wall, combinations thereof, or any other suitable support structure.

The substrate 108 may be made from a number of different heat-resistant materials. In an embodiment, the substrate 108 may be made from and/or include one or more ceramic materials, such as, beryllium oxide (“BeO”), alumina (“Al₂O₃”), an alumina-based ceramic, aluminum nitride (“AlN”), silicon carbide (“SiC”), silicon nitride (“Si₃N₄”), boron carbide (“BC”), boron nitride (“BN”), combinations thereof, or any other suitable ceramic material. Such materials may help the substrate 108 provide dimensional or structural stability to the electrodes 104. For example, the substrate 108 and the materials from which the substrate 108 are formed may exhibit a thermal expansion coefficient of less than about 4 ppm/K; less than about 5 ppm/K; less than about 7 ppm/K; less than about 10 ppm/K; or less than about 12 ppm/k. In an embodiment, the substrate 108 and the materials from which the substrate 108 are formed may exhibit a thermal expansion coefficient between about 3 ppm/K and about 12 ppm/K; between about 4 ppm/K and about 11 ppm/K; between about 5 ppm/k and about 10 ppm/K; or between about 6 ppm/K or about 9 ppm/K. In other embodiments, the substrate 108 may include one or more ceramic materials exhibiting higher or lower thermal expansion coefficients, as desired or needed for a particular application. Thus, the material properties of the substrate 108 may be selected to help support the electrodes 104, the combustion control system 100, and one or more components of a combustion system.

In other embodiments, the substrate 108 may be configured to help limit heat transfer through the combustion control system 100. For example, where limited or relatively minimal heat transfer through substrate 108 is desired, the substrate 108 may include one or more ceramic materials (e.g., silicon nitride, boron carbide, combinations thereof, or the like) exhibiting a thermal conductivity at about 600° C. of less than about 60 W/mK, less than about 50 W/mK, less than about 40 W/mK, or less than about 30 W/mK. In other embodiments, the substrate 108 may include one or more ceramic materials exhibiting a thermal conductivity at about 600° C. of between about 20 W/mK and about 60 W/mK; between about 30 W/mK and about 50 W/mK; or between about 35 W/mK and about 45 W/mK so that the substrate 108 may help insulate the combustion control system 100.

In other embodiments, the substrate 108 may include one or more ceramic materials exhibiting higher or lower thermal conductivities. For example, in an embodiment, the substrate 108 may include one or more ceramic materials (e.g., beryllium oxide, aluminum nitride, silicon carbide, combinations thereof, or any other suitable material) configured to help enable heat transfer through the combustion control system 100. In an embodiment, the substrate 108 may include one or more ceramic materials exhibiting a thermal conductivity greater than about 60 W/mK, greater than about 70 W/mK, greater than about 100 W/mK, or greater than about 220 W/mK. In other embodiments, the substrate 108 may include one or more materials exhibiting a thermal conductivity at about 600° C. of between about 60 W/mK and about 220 W/mK; between about 80 W/mK and about 180 W/mK; between about 100 W/mK and about 160 W/mK; or between about 120 W/mK and about 140 W/mK. In other embodiments, the substrate 108 may include one or more ceramic materials exhibiting higher or lower thermal conductivities. Thus, the substrate 108 may be made from selected ceramic materials to help the combustion control system 100 dissipate heat.

Referring still to FIG. 1, the combustion control system 100 may include a voltage source 110 operatively coupled to the electrodes 104. For example, one or more electrically conductive pathways (not shown) may be provided that electrically connect each of the electrodes 104 to the voltage source 110. In an embodiment, the voltage source 110 may be independently electrically coupled to each or some of the electrodes 104 so that each or some of the electrodes 104 may be independently biased to apply an electric field to the one or more regions 112 at least proximate to the flame 106. For example, the voltage source 110 and the electrodes 104 may be collectively configured to vary application of the electric field at selected locations in the electrode assembly 102 by selectively biasing one or more of the electrodes 104 independently of others. In other embodiments, the voltage source 110 may be electrically coupled to collectively all of the electrodes 104 so that the electrodes 104 may be collectively biased substantially simultaneously to apply an electric field to one or more regions 112 at least proximate to the flame 106.

The electric field may be at least partially controlled to manipulate movement of electrically charged molecules (ions) that are a natural product of the combustion process. For example, the controlled electric field may create electrostatic forces (e.g., Coulombic body forces) within a gas cloud of the flame 106 that may be manipulated to control flame shape, combustion chemistry, heat transfer through or away from a surface, or combinations thereof, as desired. For example, in an embodiment, the voltage source 110 may be configured to apply a substantially constant voltage or time-varying voltage to one or more of the electrodes 104 to generate a substantially constant or time-varying electric field strength. In another embodiment, the voltage source 110 and the electrodes 104 may be collectively configured to vary application of the electric field to the flame 106 at selected times and/or locations. In other embodiments, the voltage source 110 may be configured to change a polarity of the voltage applied to the one or more of the electrodes 104. In an embodiment, the voltage source 110 may be configured to vary a magnitude or frequency of a voltage applied by the voltage source 110 to one or more of the electrodes 104 at selected times and/or locations.

By controlling a timing, a direction, a strength, a location, a wave form, or a frequency spectrum of the electric field, or combinations thereof, the combustion control system 100 may be configured to influence combustion characteristics of the flame 106, flame shape of the flame 106, heat transfer from the flame 106, or combinations thereof. Causing a response in the flame 106 may include causing a visible response in the flame 106. Additionally or alternatively, causing a response in the flame 106 may include causing increased mixing of fuel and oxidizer in the flame 106. Causing the increased mixing of fuel and oxidizer may increase a rate of combustion. Additionally or alternatively, causing the increased mixing of fuel and oxidizer may increase fuel and air contact in the flame 106. Additionally or alternatively, causing the increased mixing of fuel and oxidizer may decrease a flame temperature. Additionally or alternatively, causing the increased mixing of fuel and oxidizer may decrease an evolution of oxides of nitrogen (“NOx”) by the flame 106. Additionally or alternatively, causing the increased mixing of fuel and oxidizer may decrease an evolution of carbon monoxide (“CO”) by the flame 106. Causing the increased mixing of fuel and oxidizer may increase flame stability and/or decrease a chance of flame blow-out. Additionally or alternatively, causing the increased mixing of fuel and oxidizer may increase flame emissivity. Additionally or alternatively, causing the increased mixing of fuel and oxidizer may decrease flame size for a given fuel flow rate.

While only one of the voltage sources 110 is shown in the illustrated embodiment, in other embodiments, the combustion control system 100 may include two, three, four, six, or any other suitable number of voltage sources. For example, in an embodiment, each of or some of the electrodes 104 may be coupled to a respective one of the voltage sources 110.

In an embodiment, the combustion control system 100 may include a burner 114 configured to support the flame 106. The burner 114 may be configured as another electrode and may be in electrical contact with a conductive surface of the flame 106. In other embodiments, the burner 114 may be configured to provide a counter voltage to cooperate with the electrodes 104 to produce the electric field. In other embodiments, the electric potential of the burner 114 may be isolated from the ground and from the voltage source 110 such that the burner 114 is electrically floating. While one burner 114 is shown, in other embodiments, the combustion control system 100 may include two, three, five, thirty, or any other suitable number of burners 114. Moreover, the burner 114 may comprise a gas burner, an oil burner, an electric burner, a can burner, a cannular burner, an annular burner, a double annular burner, or any other suitable type of burner.

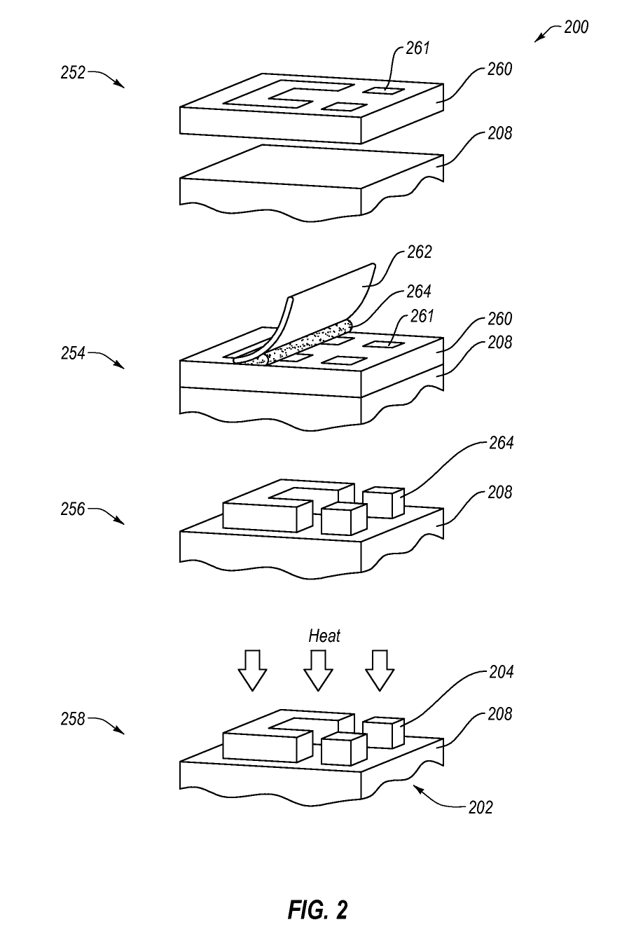

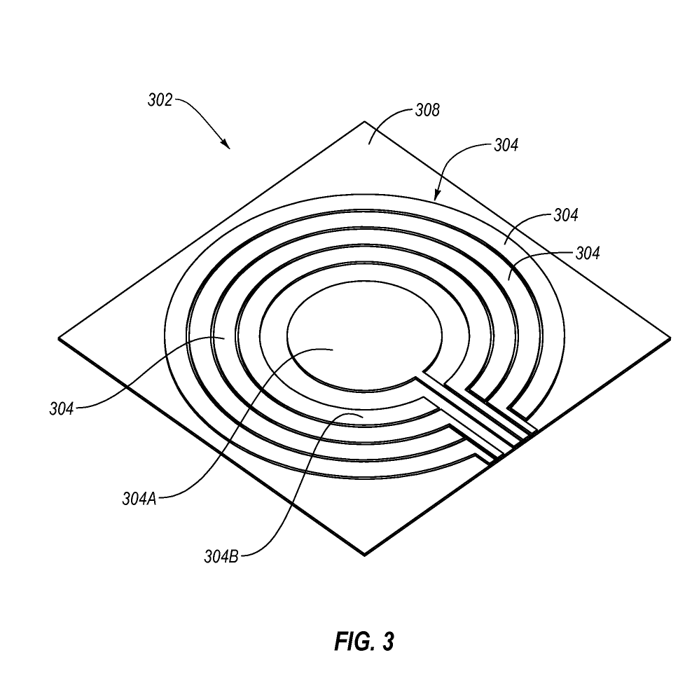

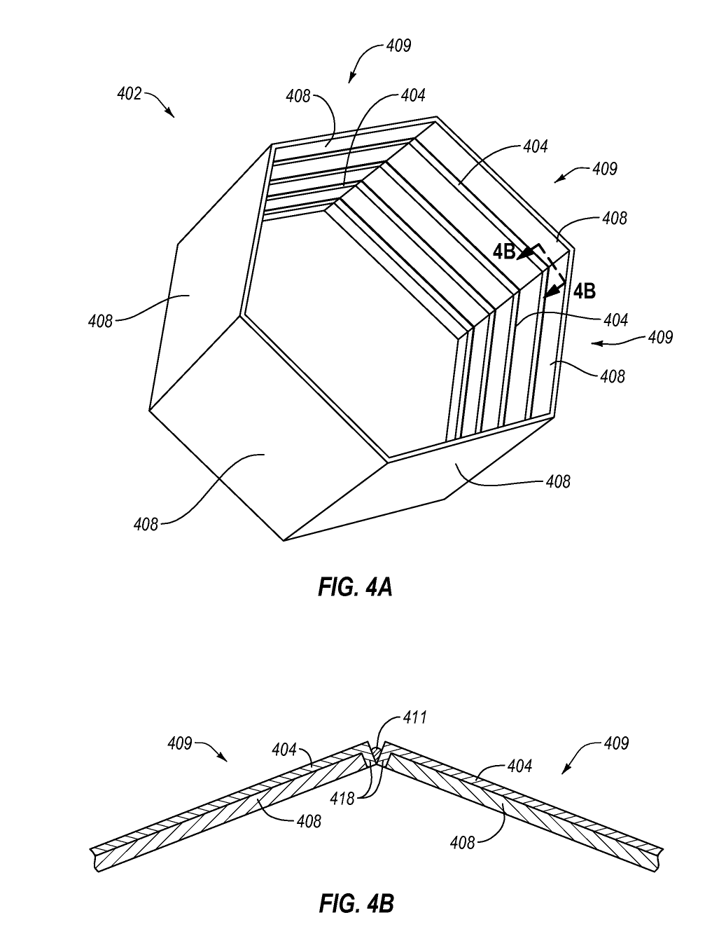

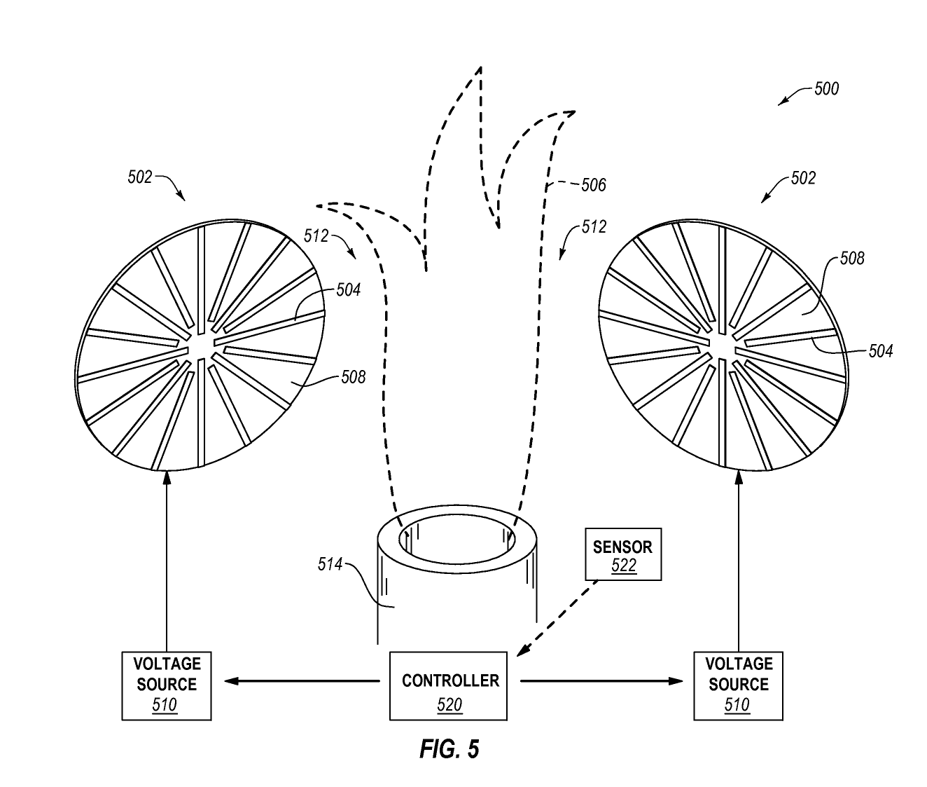

The electrode assembly 102 may be formed by a number of different processes. For example, the electrode assembly 102 may be formed via a thick-film process, an inkjet-type deposition process, a selective laser sintering process, a liquid deposition process, combinations thereof, or any other suitable process. FIG. 2 illustrates a method 200 of forming an electrode assembly 202 using a thick-film process according to an embodiment. While the method 200 is illustrated using electrode assembly 202, it will be appreciated that electrode assembly 202 may be any electrode assembly disclosed herein, such as electrode assembly 102 (FIG. 1), 302 (FIG. 3), 402 (FIG. 4A), or 502 (FIG. 5).

The method 200 includes an act 252 of positioning a stencil 260 on a substrate 208. The stencil 260 may include one or more openings 261 (e.g., slots or holes) formed therein that may define one or more patterns that at least partially determines the placement and/or physical dimensions of electrodes 204 to be formed on the substrate 208. For example, The stencil 260 may typically be made from a durable material, such as stainless steel or other suitable material. For example, the one or more openings 261 may be formed in one or more patterns, such as lines, curves, rectangles, geometric shapes, irregular geometric shapes, waves, combinations thereof, or the like. In an embodiment, the stencil 260 may exhibit a uniform thickness that may at least partially determine the thickness of the electrodes 204. In other embodiments, the stencil 260 may include one or more portions exhibiting varying thicknesses such that the thicknesses of the electrodes 204 may vary from one electrode to another or the thickness of one electrode 204 may vary. In addition, the stencil 260 may include one or more generally planar and/or curved surfaces. Accordingly, the stencil 260 may be configured such that the electrodes 204 may be formed on the substrate 208 from simple to complex patterns, fine patterns, combinations thereof, or in any suitable pattern. The stencil 260 may be formed of stainless steel or any other suitable material.

Next, the method 200 may include an act 254 of depositing a quantity of thick film paste 264 or other one or more precursor refractory metal materials on the stencil 260 that is now supported on the substrate 208. In another embodiment, a screen may placed over the stencil 260 and the thick film past 264 may be deposited on the screen. In an embodiment, the one or more precursor refractory metal materials of the thick film paste 264 may include one or more types of refractory metal material particles that have been pulverized into particulate form (e.g., a powder having an average particle size from nanometer-size scale to micron scale) and mixed with an organic binder that may have optional other glass and ceramic particles. For example, the one or more types of refractory metal material particles may include molybdenum particles, tungsten particles, niobium particles, tantalum particles, rhenium particles, particles made from alloys of one or more of the foregoing metals, combinations thereof, or any other suitable material.

As shown in FIG. 2, an applicator 262 (e.g., a squeegee) is then moved across the stencil 260 in a manner to extrude the thick film paste 264 through the one or more openings in the stencil 260 so that the thick film paste 264 is deposited on the substrate 208. In an embodiment, the applicator 262 may include a base and a blade member affixed to a lower end of the base. The blade member of the applicator 262 may be formed of material that is sufficiently pliable to effectively form a seal against the stencil 260 during printing, and sufficiently rigid to withstand dynamic forces imposed on the squeegee 262 during thick-film processing.

Next, the method 200 includes an act 256 of removing the stencil 260 from the substrate 208, thereby leaving the deposited thick film paste 264 on the substrate 208 in a selected pattern as precursor electrodes. The deposit height of the thick film paste 264 may be at least partially determined by the thickness of the stencil 260. In addition, the viscosity of the formed thick film paste 264 is sufficient such that the deposited thick film paste 264 substantially maintains the shape of the one or more openings 261 of the stencil 260.

In act 258, the deposited thick film paste 264 and the substrate 208 may be heated at a temperature between about 600° C. and about 2200° C. (e.g., about 1400° C. and about 2100° C. or about 1700° C. and about 2000° C.) for a time sufficient to effectively sinter the refractory metal material particles in the thick film paste 264 together. For example, the heating may be performed in a vacuum furnace, other generally inert atmosphere, or a non-inert atmosphere. In an embodiment, the thermal profile of the heat treatment may affect the sintering and densification of thick film paste 264. For example, an initial thermal ramp may be employed to burn off the organic binder in the thick film paste 264 and a peak soak period may be designed to sinter the refractory metal material particles together into a substantially continuous and dense network of bonded together refractory metal material particles that forms the electrodes 204. Feature dimensions (e.g., length, width, thickness, or combinations thereof) ranging from about 10 μm to about 1000 μm (e.g., about 20 μm to about 50 μm) may be formed using the thick-film process in addition to larger feature sizes such as in the millimeter scale. In other embodiments, the sintering may be effected using microwave sintering by application of microwave energy to the thick film paste 264.

In other embodiments, the process parameters may be adjusted in the method 200 to affect the electrical and/or thermal properties of the electrodes 204. Suitable examples of process parameters that may be adjusted include, but are not limited to, refractory metal material particle size and/or composition used to form the electrodes, refractory metal material particulate concentration in the thick film paste 264, glass content in the thick film paste 264, densification and porosity of the final sintered electrodes, level of sintering, combinations thereof, or another suitable process parameter. For example, sintering the refractory metal material particles together forms physical contact/electrical connections between the sintered particles. Thus, by varying the extent of sintering, the number of electrical connections between the refractory metal particles and the electrical conductivity levels through the electrodes 204 may be influenced. For example, the porosity of the final sintered electrodes 204 may be less than about 2 volume %, about 2 volume % to about 5 volume %, or about 1 volume % to about 3 volume %. As the porosity decreases, the electrical conductivity may increase.

The microstructure of the sintered refractory metal material forming the electrodes 204 is characteristic of being sintered, such as some porosity, surface roughness, distinct grain structure, or combinations thereof. In some embodiments, the surface roughness of the electrodes 204 so formed by sintering may be sufficient to initiate corona discharge according to Peek's Law when biased by a voltage source. In general, in corona discharge, ejecting ions is more likely to occur from sharply angled/pointed surface features, such as angular exterior surface grains or other surface features causing surface roughness on the electrodes 204 at least partially due to the sintered microstructure because the electric field divergence has its greatest magnitude close to such features. In Peek's Law, a sharp electrode feature has a lower corona inception voltage for ejecting ions than a dull feature.

As discussed above, in other embodiments, the refractory metal material particles may be selectively deposited in any selected electrode pattern using an ink jet type of deposition system. The as-deposited refractory metal material particles may be sintered by heating for a suitable amount of time at a suitable temperature, as discussed above in relation to FIG. 2.

In other embodiments, the refractory metal material particles may be formed into a selected electrode pattern using a selective laser sintering (“SLS”) processes. Selective laser sintering uses a high power laser (e.g., a carbon dioxide laser) to fuse/sinter small refractory metal material particles into a mass that has a desired three-dimensional shape. The laser selectively fuses/sinters the powdered refractory metal material by scanning cross-sections generated from a three-dimensional digital description of the electrode pattern (e.g., a CAD file or other scan data) on the surface of a powder bed of the refractory metal material particles.

In an embodiment, the method 200 may include an act of depositing or forming one or more conductive coatings on the sintered refractory metal material of the electrodes 204. Such a conductive coating may help decrease the electrical resistance of the electrodes 204, as previously discussed. The one or more conductive coatings may be formed or deposited on the electrodes 204 via electroplating, electroless plating, screen printing, combinations thereof, or via any other suitable technique. Such conductive coatings may include, for example, tin, manganese, vanadium, cobalt, zinc, cadmium, rhodium, chromium, titanium, nickel, silver, gold, alloys of one or more of the foregoing metals, combinations thereof, or any other suitable conductive material.

In other embodiments, the electrodes 204 need not be formed on a substrate. For example, any of the electrode formation techniques may be used, such as screen printing, hot isostatic pressing, or SLC, to form the electrodes 204 on a surface from which the electrodes 204 may be removed and separated therefrom. For example, the surface may comprise a surface having a coating from which the electrodes are relatively easily removed, such as a diamond coating or other suitable coating. In yet another embodiment, the substrate on which the electrodes 204 may be formed may be removed from the electrode assembly via machining, grinding, or combinations thereof in order to separate the electrodes from the substrate.

As previously discussed, the electrodes may be formed in a number of different patterns. For example, FIG. 3 is an isometric view of an electrode assembly 302 according to another embodiment, which includes a selected non-linear electrode pattern. The electrode assembly 302 includes a plurality of electrodes 304 having a central electrode 304A and a plurality of ring-like electrodes 304B. The central electrode 304A includes a disc-like portion and a linear portion extending between the disc-like portion and an edge of the substrate. In an embodiment, the linear portion of the central electrode 304A may be configured to electrically connect the central electrode 304A to one or more voltage sources. The ring-like electrodes 304B may be formed in a pattern that substantially surrounds the central electrode 304A. In an embodiment, each of the ring-like electrodes 304B may include an arcuate portion forming a substantial portion of a circle that substantially surrounds the central electrode 304A. Each ring-like electrode 304B further includes at least one linear portion that is connected to an end portion of the arcuate portion and extends between the edge of the substrate and the arcuate portion. In an embodiment, the linear portions of the ring-like electrodes 304B may be configured to independently or collectively electrically connect the ring-like electrodes to one or more voltage sources. In an embodiment, the ring-like electrodes 304B may be concentrically patterned, with each ring-like electrode 304B having a common center in the central electrode 304A.

The electrodes 304 and the one or more voltage sources may be collectively configured to help influence combustion characteristics of a flame (not shown). The electrodes 304 may be biased independently or collectively, as previously described with respect to FIG. 1. For example, in an embodiment, the one or more voltage sources may charge the central electrode 304A and/or the ring-like electrodes 304B in a number of different temporal and/or spatial sequences to help influence flame shape, heat transfer, mixing of gases, combinations thereof, or the like. Like the electrodes 104, the electrodes 304 may be formed from any of the sintered refractory metal materials disclosed herein. For example, the sintered refractory metal material may include sintered molybdenum, tungsten, niobium, tantalum, rhenium, alloys of one or more of the foregoing metals, combinations thereof, or any other suitable sintered material.

Referring still to FIG. 3, the electrodes 304 may be formed on and bonded to a surface of the substrate 308. The substrate 308 may be of any desired sized and geometric shape suitable for supporting the electrodes 304. For example, the substrate 308 may include a plate exhibiting a generally square-like configuration. In other embodiments, like substrate 108, the substrate 308 may exhibit any suitable geometric configuration and exhibit any suitable thickness. Moreover, like substrate 108, substrate 308 may form at least a portion of a burner body, a support surface, a furnace wall, a combustion chamber wall, combinations thereof, or any other suitable structure. As with the substrate 108, substrate 308 may be made from any suitable materials. For example, the substrate 308 may be formed from any of the materials disclosed herein used for the substrate 108. In an embodiment, the substrate 308 may include one or more generally planar surfaces. In other embodiments, the substrate 308 may include one or more surface portions that are generally curved, contoured, planar, combinations thereof, or the like.

The electrode assemblies disclosed herein may be arranged to form a number of different hollow three-dimensional structures (e.g., a hollow parallelepipeds) that at least partially surround a flame to help control one or more combustion characteristics of the flame. For example, FIG. 4A is an isometric view of an electrode assembly 402 according to another embodiment. The electrode assembly 402 may include a plurality of substrates 408 positioned and configured to form a three-dimensional structure. Each of the substrates 408 includes rows of electrodes 404 formed thereon defining a corresponding electrode sub-assembly 409. In the illustrated embodiment, the electrode sub-assemblies 409 are positioned and configured to form a hollow generally hexagonal structure, with the electrodes 404 oriented on an interior of the hollow structure. In other embodiments, the electrode assembly 402 may define other hollow structures, such as a box-like structure, a generally diamond-like structure, a generally triangular structure, or any other suitable three-dimensional structure. Such hollow configurations may enable the electrode assembly 402 to form at least a portion of a burner body, a furnace body, a combustion chamber, or any other suitable structure. Such hollow configurations may also help the electrode assembly 402 influence combustion characteristics of a flame (not shown) about which the electrode assembly 402 extends by enabling the electrode assembly 402 to apply an electric field to the flame in substantially 360° about the flame. While six of the electrode sub-assemblies 409 of the electrode assembly 402 are shown in FIG. 4A, in other embodiments, the electrode assembly 402 may include two, four, eight, ten, twelve, or any other suitable number of the electrode sub-assemblies 409.

Referring now to the partial cross-sectional view of FIG. 4B, the electrodes 404 of the electrode sub-assemblies 409 may be electrically connected to the electrodes 404 of adjacent ones of the electrode sub-assemblies 409 via any suitable technique, such as edge connectors, edge wraps, solder joints, braze joints, mechanical connections, combination thereof, or any suitable technique. In the illustrated embodiment shown in FIG. 4B, respective ones of the electrodes 404 that define a given row may be electrically connected to one another via edge electrical connectors 418 at least partially covering corners or a portion of the edges of the substrates 408. In the illustrated embodiment, the electrical connection between the edge electrical connectors 418 is established via a brazed joint 411, but soldering, welding, or other suitable metallurgical and/or mechanical joining technique may be employed. For example, suitable active braze or solder alloys including titanium may be used for effectively brazing refractory metal materials. Other suitable braze alloys include silver or gold braze alloys. In an embodiment, the electrodes 404 may be electroplated or electroless plated with a coating that is relatively more wettable than a refractory metal material, such as nickel coating. Each of the edge electrical connectors 418 may be soldered, brazed, welded, or mechanically connected to an adjacent one of the edge electrical connectors 418 from an adjacent one of the electrode sub-assemblies 409 to establish an electrical connection therebetween. For example, the edge electrical connectors 418 may be integrally formed with the electrodes 404 such as formed in the same screen printing process or formed in a separate process. Additionally, the edge electrical connectors 418 may be formed from the same or different metallic materials as the electrodes 404, such as any of the refractory metal materials disclosed herein. However, it should be noted that, in other embodiments, some or all of the electrode sub-assemblies 409 may not be electrically coupled to each other.

Referring again to FIG. 4A, the electrodes 404 may be formed on an inner surface of the structure formed by the electrode sub-assemblies 409. In the illustrated embodiment, each of the substrates 408 includes four electrodes 404, with each of the electrodes 404 being formed in a bar-like pattern. In other embodiments, like the electrodes 104 and 304, the electrodes 404 may be formed in a variety of other patterns. For example, the electrodes 404 may be formed in rectangular-like pattern, a generally elliptical pattern, a generally arcuate pattern, a generally square-like pattern, an irregular geometric pattern, a generally wave-like pattern, combinations thereof, or any other suitable pattern. Like the electrodes 104, the electrodes 404 may include and/or be formed from any of the sintered refractory metal materials disclosed herein. For example, the sintered refractory metal material may include molybdenum, tungsten, niobium, tantalum, rhenium, alloys of one or more of the foregoing metals combinations thereof, or any other suitable refractory sintered metal material.

The respective rows of the electrodes 404 and one or more voltage sources (not shown) may be collectively configured to help influence combustion characteristics of a flame (not shown). For example, the rows of the electrodes 404 may be biased independently or collectively via one or more voltage sources (not shown), as previously described with respect to FIG. 1, to influence one or more characteristics of the flame extending through the hollow of the electrode assembly 402.

FIG. 5 is a schematic isometric view of a combustion control system 500 according to another embodiment. It should be noted that the principles of the combustion control system 500 may be employed with any of the electrode assembly embodiments described herein. The combustion control system 500 may include two electrode assemblies 502, with each of the electrode assemblies 502 being positioned on generally opposite sides of a flame 506. Such a configuration may help enhance the ability of the combustion control system 500 to control combustion characteristics of the flame 506 by allowing the combustion control system 500 to apply an electric field to the flame 506 from one or more directions. Each of the electrode assemblies 502 may include a plurality of electrodes 504 formed on a substrate 508. The electrodes 504 and the substrates 508 may be formed from any of the materials and structures disclosed herein to improve resistance to heat and/or wear.

The electrodes 504 may be configured to be positioned proximate to or contacting the flame 506. In an embodiment, one or more of the electrodes 504 may be formed in a generally strip or bar-like pattern extending in a radial direction from a center of each of the substrates 508. Two or more of the electrodes 504 may exhibit different dimensions, such as length, width, thickness, or combinations thereof. Such a configuration may help the electrodes 504 control combustion characteristic of the flame 506 at different locations and/or times. While the electrodes 504 are illustrated being formed in a bar-like pattern, in other embodiments, one or more portions of the electrodes 504 may be formed in other suitable patterns.

Each of the electrode assemblies 502 may include a respective voltage source 510 operatively coupled to one or more of the electrodes 504. In an embodiment, two or more of the electrodes 504 may be selectively, electrically isolated such that the voltage sources 510 may apply a voltage to individual electrodes 504. In other embodiments, two or more of the electrodes 504 may be selectively, electrically connected to each other such that one or more of the voltage sources 510 may apply a voltage to two or more of the electrodes 504 simultaneously or nearly simultaneously. Like the voltage source 110 and the electrodes 104, one or more of the voltage sources 510 and the electrodes 504 may be collectively configured to apply an electric field to one or more regions 512 at least proximate to the flame 506.

In an embodiment, the combustion control system 500 may include one or more controllers 520 configured to control activation of at least one of the voltage sources 510. The combustion control system 500 may further include one or more sensors 522 configured to communicate with the controller 520 in response to a sensed condition of the flame 506. The sensors 522 may be configured to detect pressure, position, direction of movement of the flame 506, temperature, combustion chemical species, oxygen levels, flame dimensions or shape, flame electrical conductivity, flame electrical current, flame electrical charge distribution, combinations thereof, or any other suitable flame characteristics. For example, flame conductivity and flame current, may be measured using a-Langmuir probe, In other embodiments, the sensors 522 may be configured to detect one or more conditions associated with the electrode assembly 502, such as temperature, one or more electrical properties, position, direction, or any other suitable characteristic.

The combustion control system 500 may further include a wired or wireless transmitter (not shown) in communication with the sensors 522 and/or the controller 520, wherein the transmitter may be configured to report activity of the combustion control system 500 to an external source. The transmitter, in communication with the sensor 522 and the controller 520, may also be configured to send an activation signal to at least one of the voltage sources. In an embodiment, the controller 520 may be configured to receive an input signal (remote or local) to activate at least one of the voltage sources 510. In an embodiment, the input signal may come from operator input, a computer system, the sensor 522, or combinations thereof. Such a configuration may allow the combustion control system 500 to control one or more characteristics of the flame 506 based on one or more sensed properties or one or more signals from an external source.

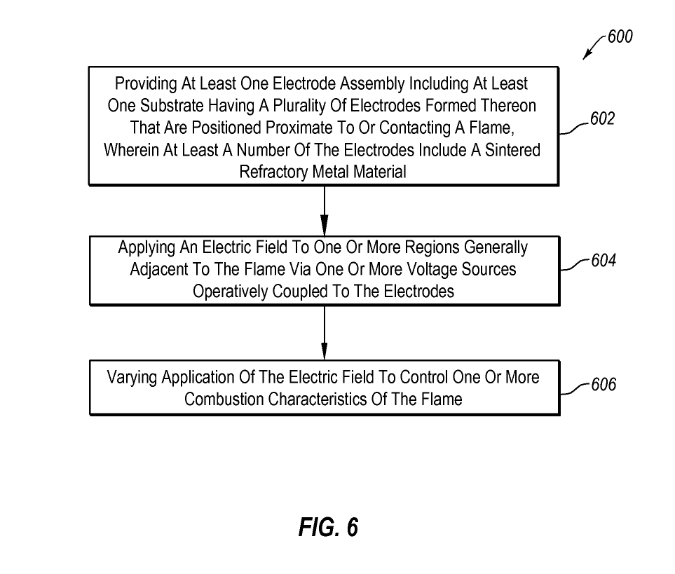

FIG. 6 is a flowchart illustrating a method 600 for controlling combustion characteristics of a flame according to an embodiment. The method 600 may be implemented by any of the electrode assembly embodiments for controlling combustion systems disclosed herein. The method 600 may include an act 602 of providing at least one electrode assembly including at least one substrate having a plurality of electrodes formed thereon that are positioned proximate to or contacting a flame. For example, any of the electrode assemblies disclosed herein may be provided proximate to or contacting the flame. At least a number of the electrodes may be formed on the substrate and may include and/or be formed from any of the sintered refractory metal materials disclosed herein. For example, in an embodiment, the act 602 may include positioning one or more electrode assemblies on different sides of the flame. In an embodiment, the act 602 may include forming at least part of a combustion chamber with the electrode assemblies such that the substrates and electrodes thereof generally surround the flame. Such a configuration may help enhance control of the one or more combustion characteristics of the flame.

Next, the method 600 may include the act 604 of applying an electric field to one or more regions at least proximate to the flame by biasing one or more of the electrodes via one or more voltage sources operatively coupled to the electrodes. The method 600 may further include the act 606 of varying application of the electric field to control one or more combustion characteristics of the flame.

In an embodiment, varying application of the electric field may include selectively charging one or more of the electrodes. In another embodiment, varying application of the electric field may include varying application of the electric field at selected locations proximate to and/or contacting the flame and/or selected times. In yet other embodiments, varying application of the electric field may include varying a voltage applied to the one or more electrodes by one or more of the voltage sources. For example, varying a voltage applied by one or more of the voltage sources may include varying a voltage applied by at least one of the voltage sources at selected times and/or locations. In other embodiments, varying a voltage applied by one or more of the voltage sources may include varying a magnitude or frequency of a voltage applied by at least one of the one or more voltage sources. For example, in an embodiment, applying a voltage to at least one of the electrodes may include applying a periodic voltage waveform having about a frequency of about 50 to about 10,000 Hz. Applying a time-varying voltage may include applying a square waveform, a sine waveform, a triangular waveform, a truncated triangular waveform, a sawtooth waveform, a logarithmic waveform, a convoluted waveform function, an arbitrary waveform function, a pulsed waveform, or an exponential waveform. Generation of such electric fields may help influence combustion characteristics of the flame, such as heat transfer or flame shape.

In an embodiment, any of the methods described herein may be performed by a computer system having at least one processor configured to execute computer-executable instructions and process operational data. For example, the processor may be operably coupled to a memory storing an application including computer-executable instructions and operational data constituting a computer program to perform acts 604 and/or 606 of the method 600 and incorporated in a controller such as the controller 520 of FIG. 5. For example, the processor may be operably coupled to a memory storing an application including computer executable instructions and operational data constituting a program to control combustion characteristics of a flame using combustion control systems 100 and/or 500.

The memory may be embodied as a computer readable medium, such as a random access memory (“RAM”), a hard disk drive, a static storage medium such as a compact disk, DVD, or other non-transitory storage medium. The memory may further store property data describing properties of the flame and/or electrode assemblies determined as described hereinabove. The computer system may further include a display coupled to the processor. The processor may be operable to display the images of the flame and other graphical illustrations of the characteristics of the flame on the display.

In some embodiments, the processor may also be operably coupled to and control operation of one or more voltage sources that apply a charge to one or more of the electrodes. For example, the memory may have computer-executable instructions stored thereon for having the processor direct one or more voltage sources to apply a charge to the electrodes such that the one or more voltage sources and the electrodes collectively apply an electric field to one or more regions at least proximate to a flame as performed in act 604 of the method 600. It will be appreciated that the computer systems described herein may include any suitable computer system including personal computers, desktop computers, laptop computers, hand-held devices, multi-processor systems, microprocessor-based or programmable consumer electronics, network PCs, minicomputers, mainframe computers, PDAs, tablets, combinations thereof, or the like.

There are numerous other embodiments, that the sintered refractory material electrodes and electrode assemblies disclosed herein may be used in. In an embodiment, a sintered refractory metal material may operate as a voltage, charge, or electric field conveyance (e.g., electrode) to or from a solid fuel. For example, a lump coal grate (an example of an assembly for delivering and/or holding solid fuel(s)) may at least support the sintered metal or refractory metal material. In an embodiment, a sintered refractory metal material may be deposited (such as electrodeposited) to contact or nearly contact a flowing fuel stream. The sintered refractory metal material deposition may include a plurality of ion ejection sources configured to ionize or convey voltage to a passing gaseous, liquid, or solid (perhaps most easily as powdered) fuel.

In an embodiment, an electrode made at least partly of sintered refractory metal metal material may be formed as a Coanda surface. In an embodiment, an electrode made at least partly of sintered refractory metal material may be formed as a fuel nozzle. In an embodiment, an electrode made at least partly of sintered refractory metal material may be formed as a fuel deflector. In an embodiment, an electrode made at least partly of sintered refractory metal material may be formed as a fuel mixer. In an embodiment, an electrode made at least partly of sintered refractory metal material may be formed as a conductive flame support surface. In an embodiment, an electrode made at least partly of sintered refractory metal material may be formed as a turbine blade. In an embodiment, an electrode made at least partly of sintered refractory metal material may be formed as a combustor wall. In an embodiment, an electrode made at least partly of sintered refractory metal material may be formed as a turbine wall, stator, or other relatively stationary part. In an embodiment, an electrode made at least partly of sintered refractory metal material may be formed as a spark arrester. In an embodiment, an electrode made at least partly of sintered refractory metal material may be formed as a flue electrode. In an embodiment, an electrode made at least partly of sintered refractory metal material may be formed as an electrostatic collection surface, scraper, or related component. In an embodiment, an electrode made at least partly of sintered refractory metal material may be formed as an arc discharge electrode. In an embodiment, an electrode made at least partly of sintered refractory metal material may be formed as a field electrode. In an embodiment, an electrode made at least partly of sintered refractory metal material may be formed as a fuel charger. In an embodiment, an electrode made at least partly of sintered refractory metal material may be formed as an electrical repulsion surface and/or as an electrical attraction surface.

One specific application is the use of the sintered refractory metal material electrodes and/or electrode assemblies in a counter electrode of an ionizer mechanism that may be incorporated into any of the combustion control systems disclosed herein, according to an embodiment. The sintered refractory metal material electrodes may exhibit a relatively high ratio of point resistance to area resistance, which makes them well suitable for counter electrode applications. An ionizer mechanism may be configured to ionize charge carriers that are then introduced to the combustion reaction for applying an electrical charge to the combustion reaction. The charge carriers can be drawn from any appropriate material or combination of materials, including, for example, components of the combustion reaction, such as oxidizer gas (e.g., air), fuel, flue gas, reactants, etc. According to an embodiment, the ionizing mechanism may include a corona electrode and counter electrode pair immersed in a flow of dielectric fluid, such as a gas, which is then introduced into the combustion volume. The corona electrode and counter electrode pair are configured to create ions from molecules of the dielectric fluid, or from other donor substances carried by the fluid.

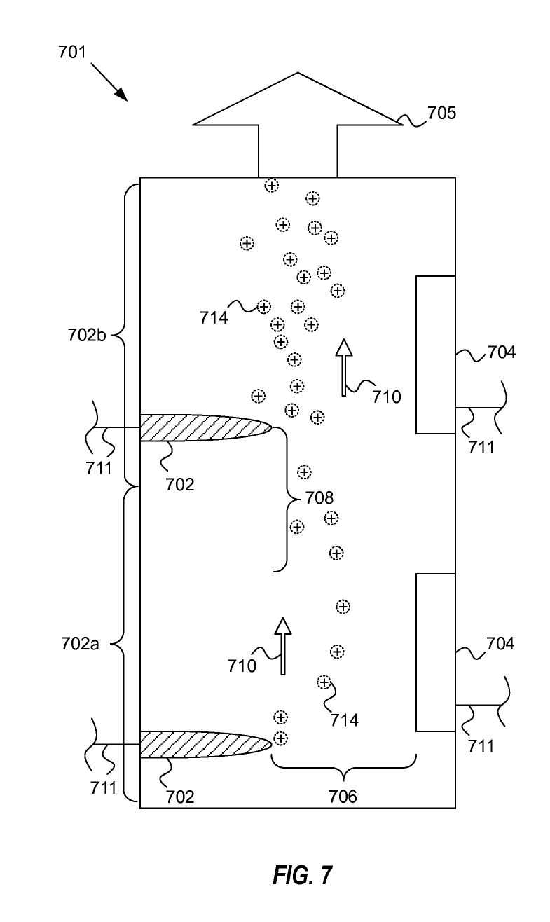

Referring to the embodiment shown in FIG. 7, an ionizer mechanism 701 includes a plurality of ionizer stages 702a, 702b each of which includes a corona electrode 702 and a counter electrode 704 spaced by an electrode separation distance 706. Each ionizer stage 702a, 702b is operably coupled to a voltage source (e.g., voltage source 110 in FIG. 1) via connectors 711. Each ionizer stage 702a, 702b is also operably coupled to a controller. The operative coupling of the ionizer stages 702a, 702b to the controller may be via the voltage source and the corresponding connector 711 or may be by any other appropriate technique, such as by a separate connector. An ion flow path 705 of ions 714 extends between the corona electrode 702 and the counter electrode 704 of each of the ionizer stages 702a, 702b. The ionizer mechanism 701 is configured to inject the charge in the form of the ions 714 traveling along the ion flow path 705. The ion flow path 705 is positioned to merge with the combustion reaction, resulting in the incorporation of the ions 714 into the combustion reaction 704. The ions 714 are shown in FIG. 7 as having a positive charge or polarity. This is merely for convenience because ions may have either a positive charge (cations) or a negative charge (anions).

A transport fluid 710 flows along the ion flow path 705 carrying ions along the flow path toward the combustion reaction. The transport fluid 710 is most commonly the substance from which the charge carriers are drawn, but in some cases, it can be a fluid in which another material is suspended, the other material being more susceptible to ionization, and thus more likely to contribute the charge carriers. For example, the transport fluid 710 is a combustion component, such as air, fuel, or EGR flue gas. The transport fluid 710 may be a dielectric or, at least has a very low electrical conductivity, in order for proper operation of the ionizer stages 702a, 702b.

In the illustrated embodiment, the first ionizer stage 702a is positioned upstream from the second ionizer stage 702b along the ion flow path 705. Further downstream from the second ionizer stage 702b, the ion flow path 705 merges with the combustion reaction. The relative positions, flow-wise (i.e., along the ion flow path 705), of the electrodes of each of the ionizer stages 702a, 702b may vary, according to the design of the system. For example, the corona electrode 702 may be aligned with the upstream edge of the counter electrode 704, or may be positioned further up- or downstream than shown. Additionally, the first and second ionizer stages 702a, 702b are spaced by an inter-ionizer separation distance 708, which represents the nearest flow-wise approach between an electrode element of the first ionizer stage 702a and an electrode element of the second ionizer stage 702b. According to an embodiment, the first and second ionizer stages 702a, 702b are positioned such that the inter-ionizer separation distance 708 is greater than the electrode separation distance 706 of the first ionizer stage 702a.

According to an embodiment, the inter-ionizer separation distance 708 is between about 1.5 times and about 2.5 times the electrode separation 706 of the first ionizer stage 702a. For example, according to an embodiment, the inter-ionizer separation distance 708 is about 2 times the electrode separation 706 of the first ionizer stage 702a. An inter-ionizer separation distance 708 that is greater than the electrode separation distance 706 tends to prevent a corona electrode 702 of one ionizer stage from interacting with a counter electrode of another ionizer stage.

Additionally, in systems in which the ionizer mechanism includes more than two ionizer stages 702a, 702b, for each adjacent pair of ionizer stages, the inter-ionizer separation 708 is, according to an embodiment, between about 1.5 and 2.5 times—more specifically about 2 times—the electrode separation 706 of the upstream one of the respective pair of ionizer stages 702. The number of ionizer stages in the plurality of ionizer stages 702 can be any number that is sufficient to produce a desired quantity of ions, including 3, 4, 5, 6, 7, 8, 9, 10, 11, or 12, for example. More details about ionizer stages in which the sintered refractory metal material electrodes and electrode assemblies may be used are disclosed in U.S. application Ser. No. 14/092,896 filed on 27 Nov. 2013, the disclosure of which is incorporated herein, in its entirety, by this reference.

While various aspects and embodiments have been disclosed herein, other aspects and embodiments are contemplated. The various aspects and embodiments disclosed herein are for purposes of illustration and are not intended to be limiting.

What is claimed is:

1. An electrode assembly for a combustion control system, comprising:
at least one substrate;
at least one electrode formed on the at least one substrate, the at least one electrode including a sintered refractory metal material, the at least one electrode configured to be mounted proximate to or contacting a flame; and
at least one voltage source operatively coupled to the at least one electrode;
wherein the at least one electrode and the at least one voltage source are collectively configured to apply an electric field to one or more regions at least proximate to the flame.

2. The electrode assembly of claim 1, wherein the sintered refractory metal material includes at least one of molybdenum, tungsten, niobium, tantalum, rhenium, or alloys thereof.

3. The electrode assembly of claim 1, wherein the at least one electrode is formed on the at least one substrate via at least one of a thick-film process, an inkjet deposition process, a selective laser sintering process, or a liquid deposition process.

4. The electrode assembly of claim 1, further comprising an electrically conductive coating that coats the at least one electrode, the electrically conductive coating exhibiting an electrical resistivity less than an electrical resistivity of the at least one electrode.

5. The electrode assembly of claim 4, wherein the electrically conductive coating includes at least one of tin, manganese, vanadium, cobalt, zinc, cadmium, rhodium, chromium, titanium, nickel, silver, gold, or alloys thereof.

6. The electrode assembly of claim 4, wherein the electrically conductive coating includes an electroplated conductive coating.

7. The electrode assembly of claim 4, wherein the electrically conductive coating includes an electroless plated conductive coating.

8. The electrode assembly of claim 1, wherein the sintered refractory metal material of the at least one electrode exhibits a surface roughness sufficient to exhibit corona discharge when biased by the at least one voltage source.

9. The electrode assembly of claim 1, wherein the at least one electrode exhibits a porosity less than about two percent.

10. The electrode assembly of claim 1, wherein the at least one electrode is formed on the at least one substrate in one or more different patterns.

11. The electrode assembly of claim 10, wherein the one or more different patterns include at least one of a generally elliptical pattern, a generally rectangular pattern, or a generally triangular pattern.

12. The electrode assembly of claim 1, wherein the at least one electrode includes a plurality of electrodes distributed in two or more rows.

13. The electrode assembly of claim 1, wherein the at least one electrode includes a plurality of electrically isolated electrodes.

14. The electrode assembly of claim 1, wherein the at least one electrode includes a plurality of electrically connected electrodes.

15. The electrode assembly of claim 1, wherein the at least one electrode includes two or more electrodes exhibiting different material properties.

16. The electrode assembly of claim 1, wherein the at least one electrode includes a plurality of electrodes, and wherein the at least one voltage source is configured to selectively charge each of the plurality of electrodes.

17. The electrode assembly of claim 1, wherein the at least one electrode includes a plurality of electrodes, and the at least one voltage source is collectively coupled to the plurality of the electrodes.

18. The electrode assembly of claim 1, wherein the at least one electrode includes a plurality of electrodes, and the at least one voltage source is independently coupled to at least a portion of the plurality of the electrodes.

19. The electrode assembly of claim 1, wherein the at least one substrate includes one or more ceramic materials.

20. The electrode assembly of claim 1, wherein the at least one substrate includes an alumina-based ceramic.

21. The electrode assembly of claim 1, wherein the at least one substrate includes at least one of aluminum oxide, beryllium oxide, aluminum nitride, silicon carbide, silicon nitride, boron carbide, or boron nitride.

22. The electrode assembly of claim 1, wherein the at least one substrate includes a plurality of substrates configured in a generally hollow hexagonal shape, a generally hollow rectangular shape, a generally hollow elliptical shape, or a generally hollow triangular shape.

23. The electrode assembly of claim 22, wherein the two or more of the plurality of substrates are connected via one or more edge electrical connectors.

24. The electrode assembly of claim 1, wherein the at least one electrode and the at least one voltage source are collectively configured to influence one or more combustion characteristics of the flame by varying application of a voltage applied by the at least one voltage source.

25. The electrode assembly of claim 1, wherein the at least one electrode and the at least one voltage source are collectively configured to influence a shape of the flame by varying application of the electric field at selected times.

26. The electrode assembly of claim 1, wherein the at least one electrode and the at least one voltage source are collectively configured to influence one or more combustion characteristics of the flame by varying a voltage applied by the at least one voltage source at selected locations and/or times.

27. The electrode assembly of claim 1, wherein the at least one electrode and the at least one voltage source are collectively configured to influence heat transfer by varying application of the electric field at selected locations and/or times.

28. The electrode assembly of claim 1, wherein the at least one electrode and the at least one voltage source are collectively configured to influence distribution of chemical species of the flame by varying application of the electric field at selected locations and/or times.

29. A combustion control system, comprising:
a combustion chamber including one or more walls at least partially defined by at least one electrode assembly including at least one substrate having at least one electrode formed thereon, the at least one electrode including a sintered refractory metal material, the at least one electrode configured to be positioned proximate to or contacting a flame; and
at least one voltage source operatively coupled to the at least one electrode;
wherein the at least one electrode and the at least one voltage source are collectively configured to apply an electric field to one or more regions at least proximate to the flame.

30. The combustion control system of claim 29, wherein the substrate includes one or more ceramic materials.

31. The combustion control system of claim 29, wherein at least one of the sintered refractory metal material exhibits a thermal conductivity greater than about 60 W/mK at about 600° C.

32. The combustion control system of claim 29, wherein the substrate exhibits an expansion coefficient less than about 10 ppm/K.

33. The electrode assembly of claim 1, wherein the at least one electrode forms at least one of at least part of:
a Coanda surface;
a fuel nozzle;
a fuel deflector;
a fuel mixer;
a conductive flame support surface;
a turbine blade;
a combustor wall;
a turbine wall;
a stator;
a spark arrester;
a flue electrode;
an electrostatic collection surface;
a scraper;
an arc discharge electrode;
a field electrode;
a fuel charger;
an electrical repulsion surface;
a counter electrode; or
an electrical attraction surface.

34. The electrode assembly of claim 1, wherein the at least one electrode and the substrate are supported by a grate configured to hold solid fuel.

35. A method of manufacturing an electrode assembly for a combustion control system, the method comprising:
providing one or more precursor refractory metal materials on a substrate, wherein the one or more precursor refractory metal materials include a plurality of refractory metal material particles; and
sintering at least a portion of the one or more precursor refractory metal materials on the substrate to form one or more electrodes, the one or more electrodes configured to be operatively coupled to one or more voltage sources so that an electric field can be applied to one or more regions at least proximate to a flame via the one or more electrodes to control one or more combustion characteristics of the flame.

36. The method of claim 35, wherein at least a portion of the plurality of refractory metal material particles includes at least one of molybdenum, tungsten, niobium, tantalum, rhenium, or alloys thereof.

37. The method of claim 35, wherein providing one or more precursor refractory metal materials on a substrate includes depositing the one or more precursor refractory metal materials on the substrate via a thick-film process, an inkjet deposition process, or a liquid deposition process.

38. The method of claim 35, wherein sintering at least a portion of the one or more precursor refractory metal materials on the substrate to form one or more electrodes is effected via a selective laser sintering process.

39. The method of claim 35, further comprising forming one or more conductive coatings on the one or more electrodes via electroplating, electroless plating, or screen printing.

40. A method of controlling combustion characteristics of a flame, the method comprising:
providing at least one electrode assembly including at least one substrate having a plurality of electrodes formed thereon that are positioned proximate to or contacting a flame, wherein at least a number of the plurality of electrodes include a sintered refractory metal material;
applying an electric field to one or more regions at least proximate to the flame via one or more voltage sources operatively coupled to the electrodes; and
varying application of the electric field to control one or more combustion characteristics of the flame.

41. The method of claim 40, wherein varying application of the electric field includes selectively charging each of the plurality of electrodes.

42. The method of claim 40, wherein varying application of the electric field includes varying application of the electric field at selected locations and/or times.

43. The method of claim 40, wherein varying application of the electric field includes varying a magnitude of a voltage applied by at least one of the one or more voltage sources.

44. The method of claim 40, wherein varying application of the electric field includes varying a voltage applied by at least one of the one or more voltage sources at selected times and/or locations.

45. The method of claim 40, wherein varying application of the electric field includes changing a polarity of a voltage through the electrodes.
